(19) United States
(12) Patent Application Publication
(10) Pub. No.: US 2024/0143039 A1
(43) Pub. Date: May 2, 2024

(54) PLATE, ELECTRONIC DEVICE HAVING THE SAME AND METHOD OF PROVIDING THEREOF

(71) Applicant: SAMSUNG ELECTRONICS CO., LTD., Suwon-si Gyeonggi-do (KR)

(72) Inventors: Giwon SEOL, Suwon-si Gyeonggi-do (KR); Jaeseon KIM, Suwon-si Gyeonggi-do (KR); Jinho LEE, Suwon-si Gyeonggi-do (KR); Jeongyeon JEON, Suwon-si Gyeonggi-do (KR); Byounghee CHOI, Suwon-si Gyeonggi-do (KR); Yongwook HWAN, Suwon-si Gyeonggi-do (KR); Junghyeon HWANG, Suwon-si Gyeonggi-do (KR)

(21) Appl. No.: 18/400,288

(22) Filed: Dec. 29, 2023

Related U.S. Application Data
(63) Continuation of application No. PCT/KR2022/010168, filed on Jul. 13, 2022.

(30) Foreign Application Priority Data
Aug. 6, 2021 (KR) 10-2021-0103623

(51) Int. Cl. G06F 1/16

(52) U.S. Cl. CPC G06F 1/1658; G06F 1/1635

(57) ABSTRACT

A plate of a housing includes a plate layer including an inner surface defining a groove which extends in an extension direction, a cut surface directly extending from the groove, a first surface roughness of the cut surface, and a second surface roughness of the inner surface which is different from the first surface roughness. The plate layer is a remaining thickness of a preliminary plate cut to remove a thickness portion thereof, the groove is a portion of a recessed pattern of the preliminary plate which is defined by the thickness portion and the remaining thickness facing each other, and the cut surface which has the first surface roughness is an exposed surface of the remaining thickness of the preliminary plate cut along a direction intersecting the extension direction of the groove to remove the thickness portion of the preliminary plate.

### CROSS-REFERENCE TO RELATED APPLICATIONS

This application is a continuation application of International Application No. PCT/KR2022/010168 designating the United States, filed on Jul. 13, 2022, at the Korean Intellectual Property Receiving Office and claiming priority to Korean Patent Application No. 10-2021-0103623 filed on Aug. 6, 2021, the disclosures of which are incorporated by reference herein in their entireties.

### BACKGROUND

### (1) Field

Embodiments of the present disclosure relate to a plate, and more particularly, to a plate included in an electronic device.

### (2) Description of the Related Art

A method of manufacturing or providing a tablet personal computer (PC) metal case with a large display may include arranging a large-capacity battery for the tablet PC within the metal case. A portion of the metal case which provides a surface on which the battery is seated may be provided with a relatively small thickness of 0.6 millimeter (mm) to 0.65 mm without a separate structure. This 0.6 mm-thick to 0.65 mm-thick plate portion of the metal case may be manufactured or provided using an aluminum alloy material which is provided through a machining process.

### SUMMARY

In a case of machining an aluminum alloy in a thin-film form such as a plate, deformation may occur due to residual stress generated in a cutting process and/or physical external forces generated by the influence of mechanical devices. The influence of mechanical devices in machining the material may include, for example, an arrangement and a seating structure of fixing devices, a clamping force, the precision of a computer numerical control (CNC) machine, and the like.

In the foregoing case of machining an aluminum alloy in a plate form, a non-uniform temperature distribution may occur on a processed surface due to a mechanical machining load generated in the cutting process, a plastic deformation between a cutting tool and a material of a processed product, and a great amount of cutting heat generated by friction, which may lead to a microstructural change and to the generation of thermal stress. The generated stress may remain even after the material is cooled, and when this residual stress exceeds the yield stress of the aluminum alloy material, a plastic behavior may occur, deforming the material. In general, residual stress occurs to a depth of approximately 500 micrometers (um) from the surface of the aluminum alloy, making the material having the small thickness a thickness of 0.6 mm to 0.65 mm more susceptible to deformation when machined, and controlling the deformation caused by such residual stress may not be easy.

As a result of analysis of a cutting process simulation, heat generated in the cutting process may instantaneously reach up to 400 degrees Celsius (° C.) despite the control of cutting conditions and the cooling using a cutting oil.

Various embodiments of the present disclosure provide a plate whose durability is enhanced as heat generated in a cutting process for the plate is effectively cooled and a potential thermal deformation occurring on one surface of the plate is reduced, and provide an electronic device including the plate.

According to an embodiment, a plate may include a first part forming a portion of the plate, a second part disposed on one side of the first part, and at least one processed part of the first part and the second part, where the processed part may penetrate the first part and form a groove in a portion of the second part, a cutting process may be performed on the first part, and a first surface roughness of one surface of the plate exposed by the cutting process may be different from a second surface roughness of an inner surface of the groove of the second part.

According to an embodiment, an electronic device may include a battery and a plate on which the battery is seated, where the plate may include a first part forming a portion of the plate, a second part disposed on one side of the first part, and at least one processed part of the first part and the second part, where the processed part may penetrate the first part and form a groove in a portion of the second part, a cutting process may be performed on the first part, and a first surface roughness of one surface of the plate exposed by the cutting process may be less than a second surface roughness of an inner surface of the groove of the second part.

According to an embodiment, an electronic device may include a battery and a plate on which the battery is seated, where the plate may include a flat part (e.g., a second part) formed as substantially flat, where the flat part may include a first surface (e.g., one surface of a second part) formed to have a first surface roughness by a cutting process and a second surface (e.g., a groove of the second part) that is disposed in a portion of the first surface and formed to have a second surface roughness greater than the first surface roughness.

According to various embodiments, forming a groove on one surface of a plate and then performing a cutting process may effectively cool the heat generated on one surface of the plate and reduce the occurrences of thermal deformation, thereby enhancing the durability of the plate.

In addition to the effects described above, other various effects that may be verified directly or indirectly may be provided in the following description.

### BRIEF DESCRIPTION OF THE DRAWINGS

The above and other advantages and features of this disclosure will become more apparent by describing in further detail embodiments thereof with reference to the accompanying drawings, in which:

FIG. 1 is a block diagram illustrating an electronic device in a network environment according to an embodiment.

FIG. 2 is a flowchart schematically illustrating a method of manufacturing or providing a plate according to an embodiment.

FIG. 3 is a diagram illustrating a first surface of a plate providing a housing of an electronic device according to an embodiment.

FIG. 4A is a front view schematically illustrating a pattern defined in a plate according to an embodiment.

FIG. 4B is a perspective view illustrating a pattern defined in a plate according to an embodiment.

FIG. 4C is a cross-sectional view illustrating a pattern defined in a plate according to an embodiment.

FIGS. 4D and 4E are cross-sectional views illustrating a change in surface roughness of a plate pattern by a chemical etching process performed on the plate according to an embodiment.

FIG. 4F is a diagram illustrating a cutting process performed on a plate according to an embodiment.

FIG. 4G is a diagram illustrating a completed plate according to an embodiment.

FIG. 5A is a diagram illustrating various shapes of a pattern defined in a plate according to an embodiment.

FIG. 5B is a diagram illustrating various shapes of a pattern defined in a completed plate according to an embodiment.

FIGS. 6A through 6D are plan view diagrams respectively illustrating examples of a progress direction of a cutting process performed on a plate according to an embodiment.

FIGS. 7A through 7C are plan view diagrams illustrating examples of patterns defined in a plate which extend in a first direction according to an embodiment.

FIGS. 8A through 8C are plan view diagrams illustrating examples of patterns defined in a plate which extend in a second direction crossing the first direction according to an embodiment.

FIGS. 9A through 9F are plan view diagrams illustrating examples of patterns defined in a plate which extend in directions inclined to the first direction and to the second direction according to an embodiment.

FIG. 10 is a plan view diagram illustrating an example of patterns defined in a plate which extend radial directions according to an embodiment.

### DETAILED DESCRIPTION

Hereinafter, various embodiments will be described in greater detail with reference to the accompanying drawings. When describing the embodiments with reference to the accompanying drawings, like reference numerals refer to like elements and a repeated description related thereto will be omitted.

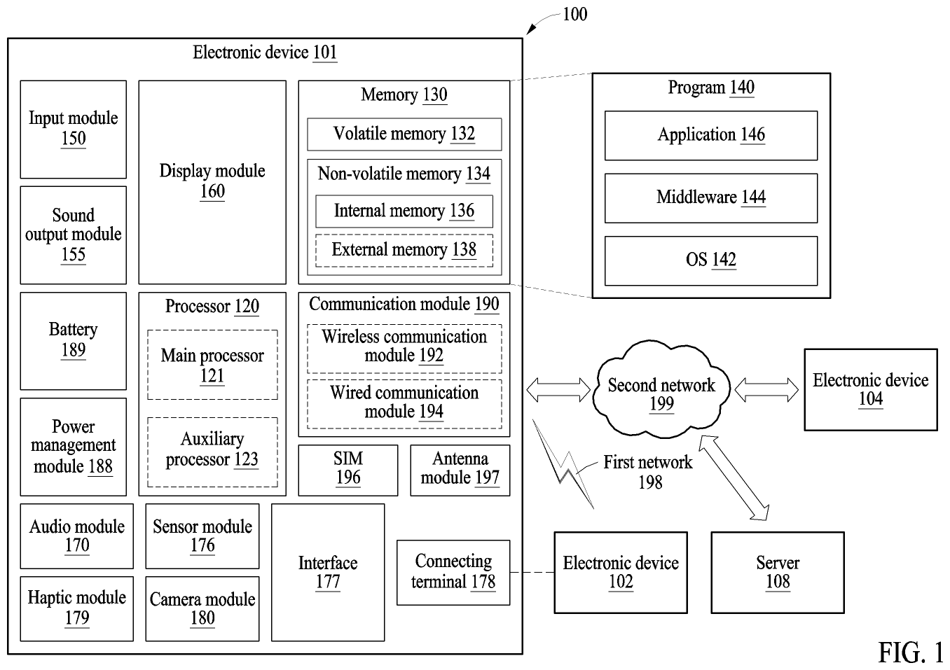

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with at least one selected from an external electronic device 104 and a server 108 via a second network 199 (e.g., a long-range wireless communication network). The electronic device 101 may communicate with the external electronic device 104 via the server 108.

The electronic device 101 includes a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. At least one (e.g., the connecting terminal 178) selected from the above components may be omitted from the electronic device 101, or one or more other components may be added in the electronic device 101. Some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. As at least a part of data processing or computation, the processor 120 may store a command or data received from another component (e.g., the sensor module 176 or the communication module 190) in a volatile memory 132, process the command or data stored in the volatile memory 132, and store resulting data in a non-volatile memory 134.

The processor 120 includes a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with, the main processor 121. In an embodiment, for example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) selected from the components of the electronic device 101, instead of the main processor 121 while the main processor 121 is in an inactive (e.g., sleep) state or along with the main processor 121 while the main processor 121 is an active state (e.g., executing an application). The auxiliary processor 123 (e.g., an ISP or a CP) may be implemented as a portion of another component (e.g., the camera module 180 or the communication module 190) that is functionally related to the auxiliary processor 123.

The auxiliary processor 123 (e.g., an NPU) may include a hardware structure specified for artificial intelligence (AI) model processing. An AI model may be generated by machine learning. Such learning may be performed by, for example, the electronic device 101 in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 includes the volatile memory 132 or the non-volatile memory 134. The non-volatile memory 134 includes an internal memory 136 and an external memory 138.

The program 140 may be stored as software in the memory 130, and includes, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing records. The receiver may be used to receive an incoming call. The receiver may be implemented separately from the speaker or as a part of the speaker.

The display module 160 may visually provide information to the outside (e.g., a user) of the electronic device 101. The display module 160 may include, for example, a display, a hologram device, or a projector, and a control circuitry to control a corresponding one of the display, the hologram device, and the projector. The display module 160 may include a touch sensor adapted to sense a touch, or a pressure sensor adapted to measure an intensity of a force incurred by the touch.

The audio module 170 may convert a sound into an electric signal or vice versa. The audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101 and may generate an electric signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with an external electronic device (e.g., the electronic device 102) directly (e.g., by wire) or wirelessly. The interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). The connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. The haptic module 179 may include, for example, a motor, a piezoelectric element, or an electric stimulator.

The camera module 180 may capture a still image and moving images. The camera module 180 may include one or more lenses, image sensors, ISPs, or flashes.

The power management module 188 may manage power supplied to the electronic device 101. The power management module 188 may be implemented as, for example, at least a part of a power management integrated circuit (PMIC).

The battery 189 may supply power to at least one component of the electronic device 101. The battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and an external electronic device (e.g., the electronic device 102, the external electronic device 104, or the server 108) and performing communication via the established communication channel. The communication module 190 may include one or more communication processors that are operable independently of the processor 120 (e.g., an AP) and that support direct (e.g., wired) communication or wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the external electronic device 104), or a network system (e.g., the second network 199). The wireless communication module 192 may support a peak data rate (e.g., 20 gigabits per second (Gbps) or more for implementing eMBB, loss coverage (e.g., 164 dB or less) for implementing mMTC, or U-plane latency (e.g., 0.5 millisecond (ms) or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. The antenna module 197 may include an antenna including a radiating element including a conductive material or a conductive pattern formed in or on a substrate (e.g., a printed circuit board (PCB)). The antenna module 197 may include a plurality of antennas (e.g., array antennas). In such an embodiment, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. Another component (e.g., a radio frequency integrated circuit (RFIC)) other than the radiating element may be additionally formed as or defined by a part of the antenna module 197.

The antenna module 197 may form a mmWave antenna module. The mmWave antenna module may include a PCB, an RFIC disposed on a first surface (e.g., a bottom surface) of the PCB or adjacent to the first surface and capable of supporting a designated high-frequency band (e.g., the mmWave band), and a plurality of antennas (e.g., an antenna array) disposed on a second surface (e.g., a top or a side surface) of the PCB or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. All or some of operations to be executed by the electronic device 101 may be executed at one or more of (or at least one selected from) the external electronic devices 102, 104, and 108. In an embodiment, for example, if the electronic device 101 is desired to perform a function or a service automatically, or in response to a request from a user or another device, the electronic device 101, instead of, or in addition to, executing the function or the service, may request one or more external electronic devices to perform at least a part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least a part of a reply to the request. To that end, a cloud computing, distributed computing, mobile edge computing (MEC), or client-server computing technology may be used, for example. The electronic device 101 may provide ultra-low latency services using, e.g., distributed computing or mobile edge computing. In an embodiment, for example, the external electronic device 104 may include an Internet-of-things (IoT) device. The server 108 may be an intelligent server using machine learning and/or a neural network. The external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment described herein, an electronic device may be a device of one of various types. The electronic device may include, as non-limiting examples, a portable communication device (e.g., a smartphone), a computing device, a portable multimedia device, a portable medical device, a camera, a wearable device, or a home appliance. However, the electronic device is not limited to the foregoing examples.

It is to be understood that various embodiments of the disclosure and the terms used therein are not intended to limit the technological features set forth herein to some embodiments, but include various changes, equivalents, or replacements for a corresponding embodiment. In connection with the description of the drawings, like reference numerals may be used for similar or related components.

It is to be understood that a singular form of a noun corresponding to an item may include one or more of the things unless the relevant context clearly indicates otherwise. Within the Figures and the text of the disclosure, a reference number indicating a singular form of an element may also be used to reference a plurality of the singular element.

As used herein, “A or B,” “at least one of A and B,” “at least one of A or B,” “A, B, or C,” “at least one of A, B, and C,” and “at least one of A, B, or C,” each of which may include any one of the items listed together in the corresponding one of the phrases, or all possible combinations thereof. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Terms such as “1st” and “2nd” or “first” and “second” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it denotes that the element may be coupled with the other element directly (e.g., by wire), wirelessly, or via a third element.

It will be understood that when an element is referred to as being related to another element such as being “on” or “connected to” another element, it can be directly on the other element or intervening elements may be present therebetween. In contrast, when an element is referred to as being related to another element such as being “directly on” or “directly connected to” another element, there are no intervening elements present.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in connection with some embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Various embodiments set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply denotes that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method described herein may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

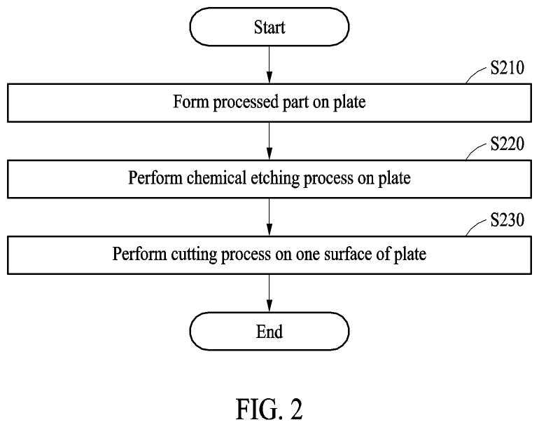

FIG. 2 is a flowchart schematically illustrating a method of manufacturing (or providing) a plate according to an embodiment. More particularly, FIG. 2 illustrates a method of providing a plate included in a housing of various electronic devices.

Referring to FIG. 2, a method of manufacturing a plate according to an embodiment may include operation S210 of providing (or forming) a processed part on the plate, operation S220 of performing a chemical etching process on the plate, and operation S230 of performing a cutting process on the plate. The plate described herein, which is a component constituting a portion of a housing of an electronic device (e.g., the electronic device 101 of FIG. 1), may support a battery (e.g., the battery 189 of FIG. 1) at one surface of a completed plate processed according to the methods disclosed or suggested herein.

In the method of manufacturing the plate according to an embodiment, operation S210 of forming the processed part on the plate may be performed before operation S230 of performing the cutting process on one surface of the plate. That is, to manufacture the plate to have a preset thickness, the processed part may be first formed on one surface of the plate before the cutting process is performed. For example, the processed part may be provided in the form of a groove on the plate. Since the cutting process is performed when the processed part in the form of a groove is formed on the plate beforehand, the processed part may function as a cooling channel and reduce thermal deformation of one surface of the plate on which the battery is seated.

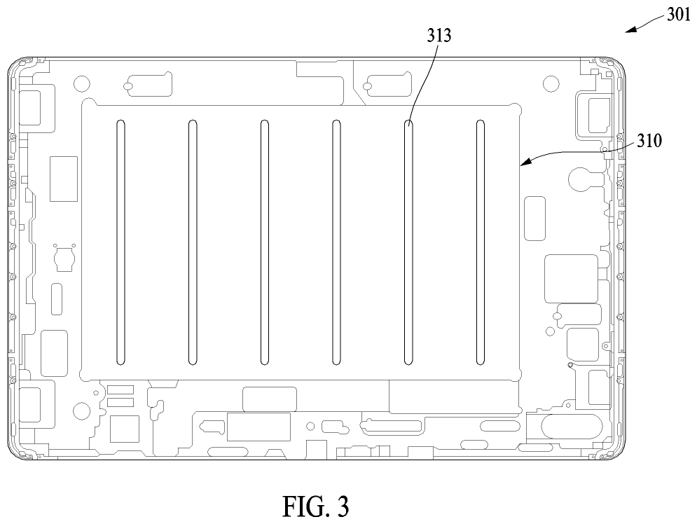

FIG. 3 is a diagram illustrating a first surface (e.g., an inner surface) of a plate 310 forming a portion of a housing 301 of an electronic device (e.g., the electronic device 101 of FIG. 1) according to an embodiment.

Although, according to related art, there is no separate processed part formed from one surface of a plate that forms a conventional housing of a conventional electronic device and supports a battery. In contrast, a separate processed part 313 in the form of a groove may be provided on or at a first surface of the plate 310 defining the portion of the housing 301 of the electronic device according to an embodiment of the present disclosure.

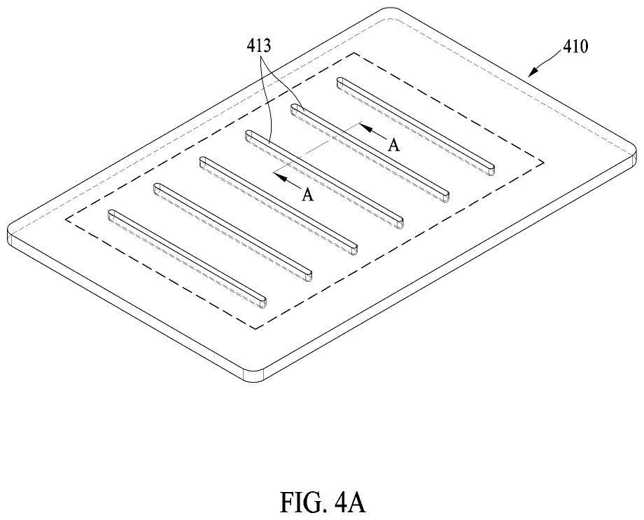

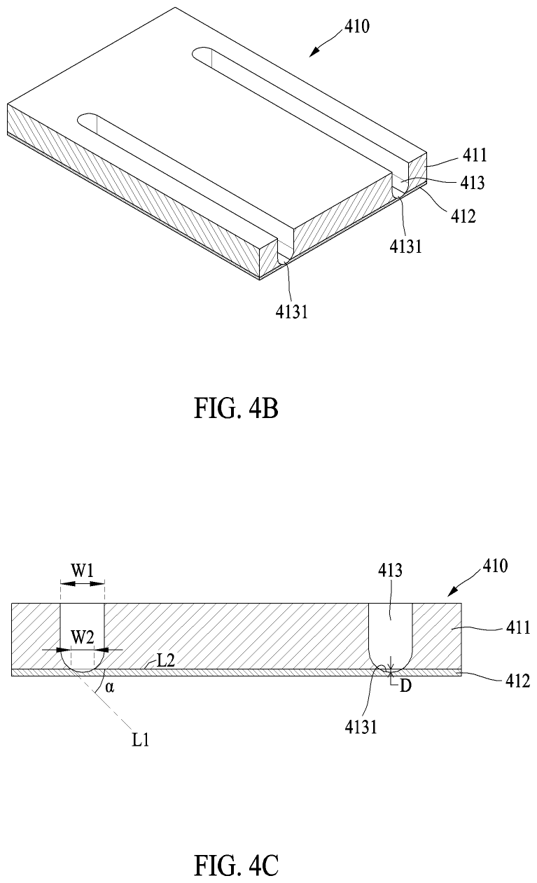

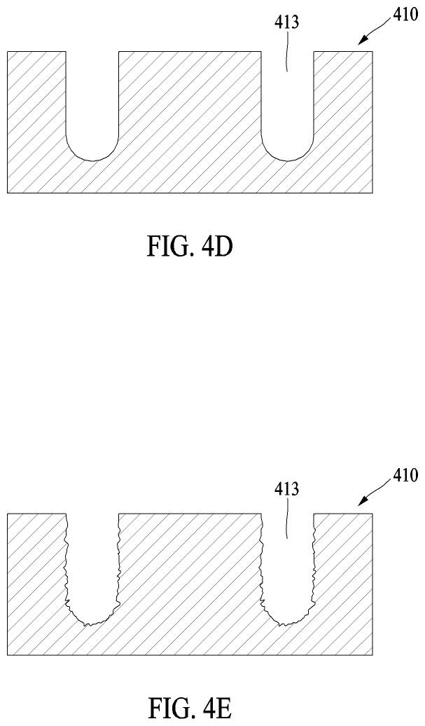

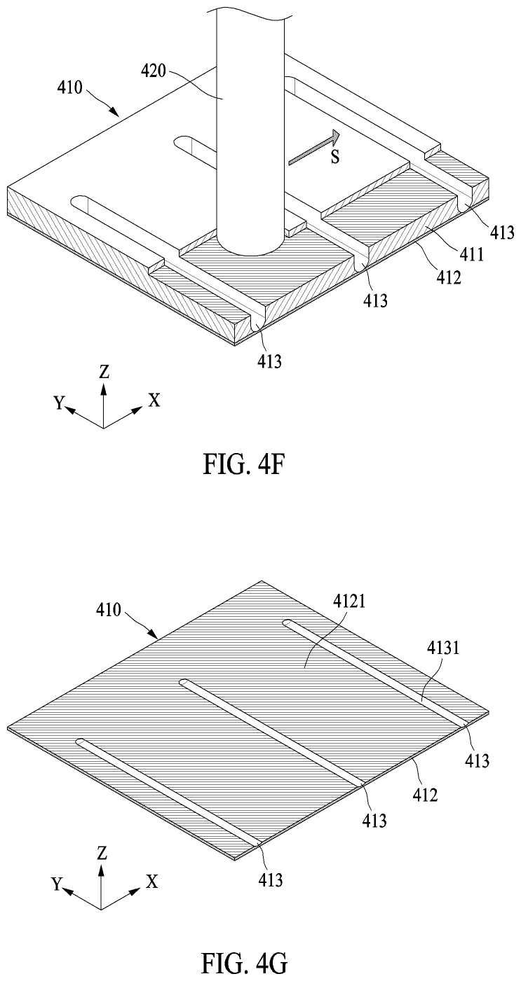

Hereinafter, a housing plate according to an embodiment will be described in detail with reference to FIGS. 4A to 4F.

FIG. 4A is a front view schematically illustrating a processed part formed on or defined in a plate according to an embodiment, FIG. 4B is a perspective view illustrating a processed part of a plate according to an embodiment, and FIG. 4C is a cross-sectional view illustrating a processed part of a plate according to an embodiment. In addition, FIGS. 4D and 4E are cross-sectional views illustrating a change in surface roughness of a processed part by a chemical etching process performed on a plate according to an embodiment, FIG. 4F is a diagram illustrating a cutting process performed on a first part of a plate according to an embodiment, and FIG. 4G is a diagram illustrating a state of a completed housing plate according to an embodiment.

Referring to FIGS. 4A and 4B, a plate 410 (e.g., the plate 310 of the housing 301 of FIG. 3) according to an embodiment may include a first part 411 forming a portion of the plate 410, a second part 412 disposed on one side of the first part 411 to face the first part 411, and at least one processed part 413 (e.g., the processed part 313 of FIG. 3) of the first part and the second part. The processed part 413 may penetrate a thickness of the first part 411 and form a groove in a portion of the second part 412. In this case, a plurality of processed parts 413 may be arranged to be spaced apart from each other at a preset distance in a direction along the plate 410. Although the processed part 413 is shown as six processed parts of a plate in FIG. 4A, the number of which is not limited thereto.

The plate 410 may be disposed in a plane defined by a first direction and a second direction crossing each other. Referring to FIG. 4A, for example, the plate 410 may have a short dimension in a first direction and a long dimension in a second direction. A thickness of the plate (or the electronic device) may be defined along a third direction which crosses both of the first direction and the second direction. The third direction may be referred to as a thickness direction.

FIG. 4C is a cross-sectional view of a plate viewed in a direction A of FIG. 4A, along the line A-A and, referring thereto, the first part 411 and the second part 412 may be formed of or include the same material. That is, the first part 411 as a first thickness portion and the second part 412 as a second thickness portion of the plate 410 may be formed of the same metal material. For example, the plate 410 may be formed of aluminum, stainless steel, magnesium, and/or a combination of at least two thereof.

The first part 411 may be a first thickness portion or a first layer at which the cutting process described below is to be performed, and the second part 412 may be a second thickness portion or a second layer of the plate that remains after the cutting process to form the housing of the electronic device. In this case, the second part 412 may have a total (or maximum) thickness of approximately 0.6 millimeter (mm) to approximately 0.65 mm. However, it should be noted that the thickness of the second part 412 is not necessarily limited thereto.

In addition, the processed part 413 may have a major dimension such as length extended in a first direction (e.g., extension direction) and a minor dimension such a width extended in a second direction (e.g., width direction), in a plan view. Referring to FIG. 4C, a first width W1 of the processed part 413 formed through the first part 411 of the plate 410 may be formed to be approximately 4 millimeters (mm) or greater, and a second width W2 of a groove 4131 of the second part 412 of the plate 410 may be formed to be approximately 1.5 mm or greater. To prevent an excessive increase in processing time for forming a plurality of processed parts 413, such a foregoing numerical range may need to be required and may also be considered for a processed part to function as an effective cooling channel.

A first portion of the processed part 413 is defined by an inner surface of the first layer 411 and a second portion of the processed part 413 is defined by an inner surface of the second layer 412. The first portion may completely penetrate a thickness of the first layer 411 while the second portion may partially penetrate a thickness of the second layer 412. The first width W1 is defined at the first layer 411. The second width W2 is defined by the first layer 411 or the second layer 412, at an interface of the first layer 411 with the second layer 412. The second width W2 is smaller than the first width W1. The groove or recessed pattern which defines the processed part 413 is open at an upper (first) surface of the plate 410 which is defined by the first layer 411. A lower (second) surface of the plate 410 is opposite to the first surface and is defined by the second layer 412. A thickness portion of the second layer 412 is defined at a bottom of the groove, such that the processed part 413 is open at one surface of the plate 410.

In addition, a depth D of the groove 4131 of the processed part 413 at the second part 412 may be formed to be shallower, with less than ½ of a total thickness of the second part 412. For example, in a case in which the total thickness of the second part 412 is formed to be 0.6 mm, the depth D of the groove 4131 of the processed part 413 formed in the second part 412 may be formed to be 0.3 mm or less.

Further, an edge portion of the processed part 413 formed in the second part 412 may be a portion that is in physical contact with a battery seated on one surface of the second part 412. An angle α formed between a tangent line L1 (e.g., first tangent line) contacting the edge portion of the processed part 413 formed at the inner surface of the second part 412, and a horizontal line L2 (e.g., a second tangent line) coplanar with the upper surface of the second part 412, may be formed to be within approximately 45 degrees (°) to ensure the stability of the battery. That is, the disclosed angle may prevent the edge portion of the processed part 413 formed in the second part 412 from having an excessively angled shape.

Referring to FIGS. 4D and 4E, at least one processed part 413 may be of the plate 410 such as through computer numerical control (CNC) machining. As shown in FIG. 4D, for example, the CNC machining may be performed such that the inner surfaces of the processed part 413 at the first layer 411 and the second layer 412 is formed to have a surface roughness (e.g., an initial surface roughness or a first surface roughness) in a range of about Ra 0.25 um to about Ra 0.32 um. Subsequently, a chemical etching process may be performed on the plate 410 as shown in FIG. 4E. For example, the chemical etching process may be performed on the inner surface of the processed part 413 of the plate 410. As a result, the surface roughness (e.g., a second surface roughness) of the inner surface of the plate 410 at the processed part 413 may be about Ra 2.0 um or greater. For example, the chemical etching process may be performed using a T treatment or TRI process included in a metal manufacturing process. Here, an uneven shape of an inner surface of the plate 410 at a completed processed part formed by the chemical etching process may have a total surface area about two times that of a total surface area of the preliminary processed part formed by the CNC machining, facilitating more effective cooling.

Referring to FIG. 4F, after the chemical etching process described above is performed, a thickness portion (e.g., a third thickness portion) of the first part 411 of the plate 410 may be removed such as through a cutting process performed using a cutting tool 420 (e.g., a cutter). In this case, a progress path S of the cutter within the cutting process for the first part 411 may be in a direction inclined with respect to an extension direction or major dimension of the processed part 413. That is, the progress path S of the cutting process may be set so that it is not parallel to a direction in which the processed part 413 extends. For example, the progress path S of the cutting process for the first part 411 may be in a direction orthogonal to the processed part 413. The progress path S may define a movement direction of the cutter along the plate 410 having the first part 411 thereon, at a location of the plate 410. The cutter may be moved along the movement direction, at positions or locations defined along the extension direction of the processed part 413, to remove thickness portions of the first part 411 until the one surface 4121 is exposed from the first part 411.

In this process, a plurality of processed parts 413 disposed discontinuously or spaced apart from each other along the plate 410 may discontinuously cut off the heat generated during the cutting process, which may facilitate the cooling. In addition, it is to be noted that the processed part 413 may improve the cooling efficiency of the plate 410 by additionally applying a cutting oil that may be supplied during the cutting process. As a result, a bending phenomenon that may occur in a plate processing process may be reduced, and as a bending process involved in the plate processing process is removed, a yield of production of a plurality of plates may be increased.

For example, referring to FIG. 4F together with 4G, an entirety of the thickness of the plate 410 may be removed through the cutting process, and one surface of the second part 412 of the plate 410 (e.g., an upper surface) may be exposed to outside the plate 410 as shown in FIG. 4G. That is, the first layer 411 may be sacrificial layer which is removable from a remainder of the plate 410. The processed part 413 may remain in the form of a groove defined in the second part 412. In this case, a first surface roughness of the exposed one surface 4121 (e.g., an exposed surface) of the second part 412 may be different from a second surface roughness of an inner surface of the second part 412 at the groove 4131 of the processed part 413 of the second part 412. For example, the second surface roughness of the inner surface of the second part 412 which defines the groove 4131 of the processed part 413 may be greater than the first surface roughness of the exposed one surface 4121 of the second part 412 which extends from the groove 4131.

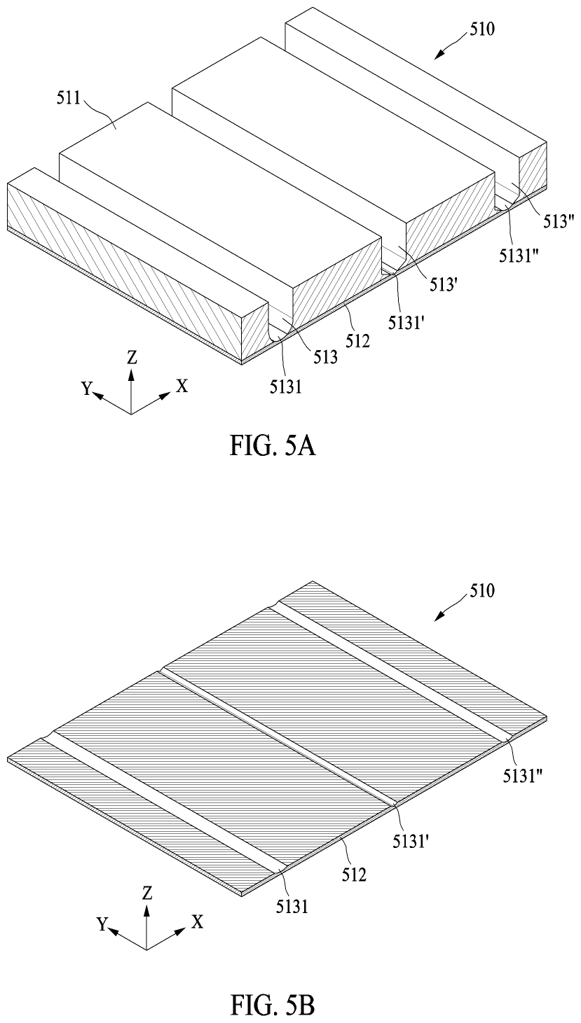

Referring to FIGS. 5A and 5B, a cross-sectional shape of a processed part (e.g., processed parts 513, 513′, and 513″) (e.g., the processed part 313 of FIG. 3 or the processed part 413 of FIGS. 4A to 4F) as a preliminary processed part of a plate 510 (e.g., the plate 310 of FIG. 3 or the plate 410 of FIGS. 4A to 4F) may be substantially circular or polygonal (e.g., be a portion of a circle or a virtual polygon). The cross-sectional shape may be extended along the major dimension of a respective processed part to define the elongated shape of the respective processed part. For example, a cross section of the processed part 513 may be formed to have a substantially circular shape. Alternatively, for example, a cross section of the processed part 513′ may be formed in a triangular shape (e.g., a virtual shape such as a triangle). Alternatively, for example, a cross section of one end of the processed portion 513′″ may be formed in a polygonal shape with four or more faces. As a result, a cross-sectional shape of respective grooves 5131, 5131′, and 5131″ of the processed parts 513, 513′, and 513″ as completed processed part formed in a second part 512 (e.g., the second part 412 of FIGS. 4A to 4F) that remained after removing a total thickness of the first part 511 by the cutting process may be formed to be substantially circular or polygonal (e.g., a portion of a circle or a portion of a polygon).

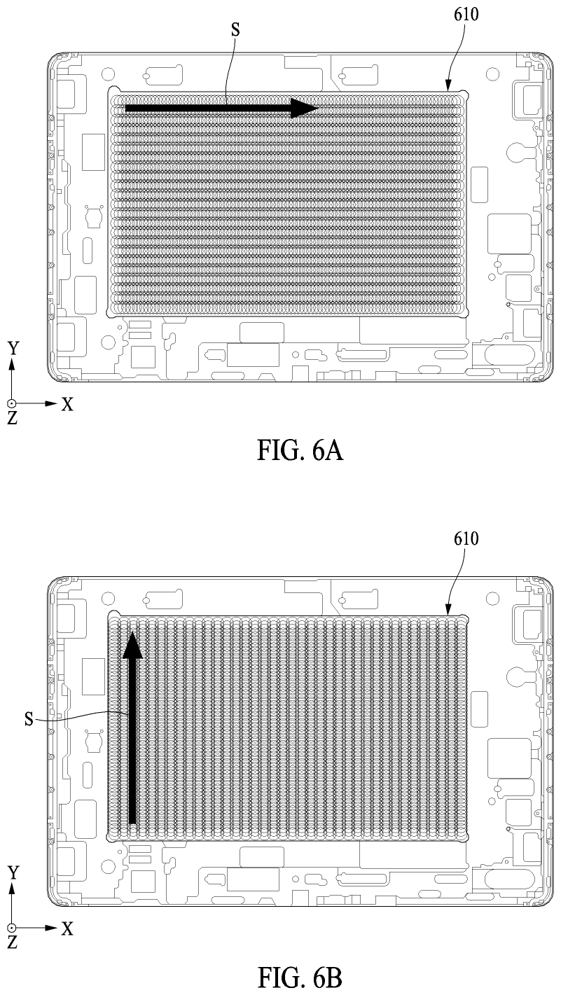

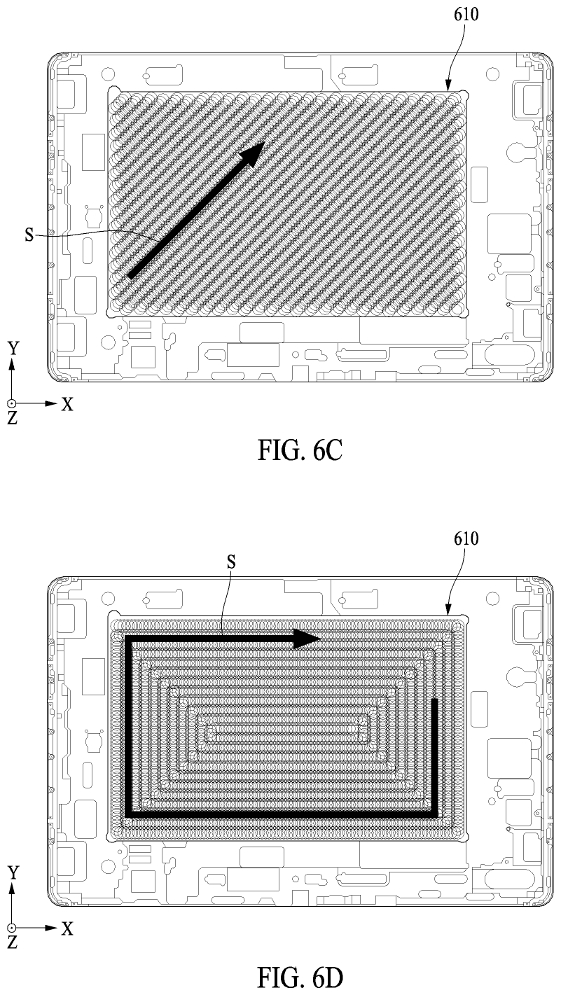

Referring to FIGS. 6A to 6D, a progress path S of a cutting process for removing one or more thickness portions of a first part of a plate, which is described above, may be in an X-axis direction, a Y-axis direction, a diagonal direction inclined with respect to the X-axis direction or the Y-axis direction, or a spiral direction on a plane of a plate 610 (e.g., the plate 310 of FIG. 3, the plate 410 of FIGS. 4A to 4F, or the plate 510 of FIGS. 5A and 5B).

For example, the progress path S of the cutting process may be along the X-axis direction on the plane of the plate 610 as shown in FIG. 6A, or the progress path S of the cutting process may be along the Y-axis direction on the plane of the plate 610 as shown in FIG. 6B. Alternatively, for example, the progress path S of the cutting process may be along a direction inclined with respect to an X-axis or a Y-axis on the plane of the plate 610 as shown in FIG. 6C, or the progress path S of the cutting process may be along the spiral direction on the plane of the plate 610 as shown in FIG. 6D. The movement of the cutter may be repeated along the various progress paths S until a desired thickness portion and/or planar portion of the first part is removed for exposing the second part. As illustrated in FIG. 4F, the direction of the progress path S may intersect the extension direction of the respective processed part.

Although the progress path S of the cutting process is shown in FIG. 6C as being formed in a direction inclined to have a positive (+) inclination value with respect to the X-axis, examples thereof are not limited thereto, but the progress path S of the cutting process may also be formed in a direction inclined to have a negative (−) inclination value with respect to the X-axis. In addition, although the progress path S of the cutting process is shown in FIG. 6D as being formed in a spiral direction from the outside of the plate 610 toward the inside thereof, examples thereof are not limited thereto, but the progress path S of the cutting process may also be formed in a spiral direction from the inside toward the outside.

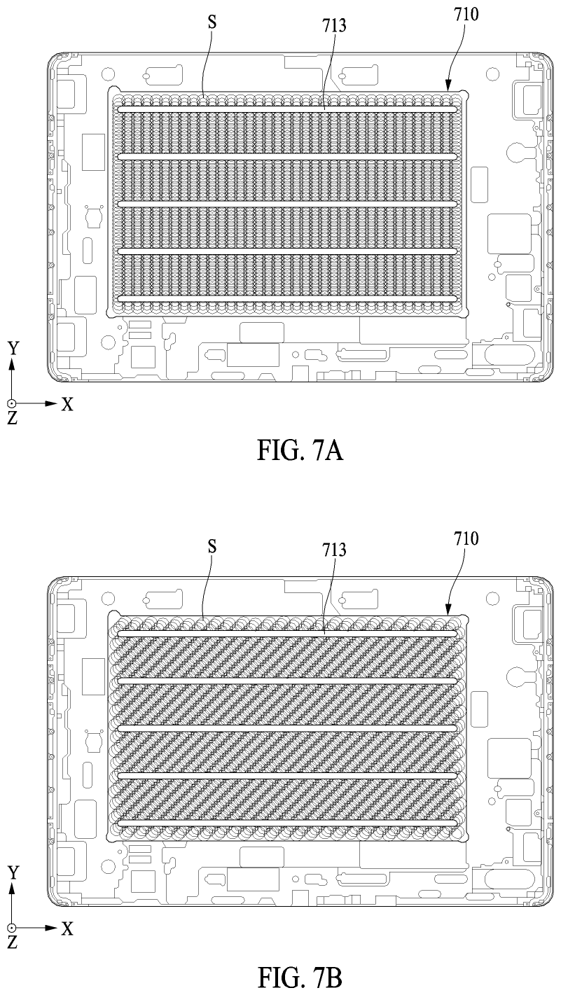

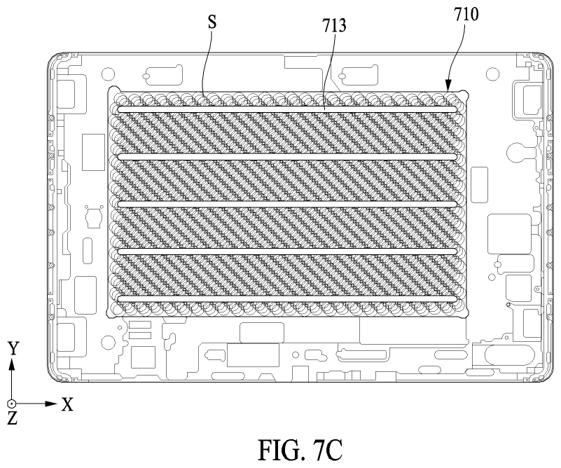

Referring to FIGS. 7A to 7C, a processed part 713 (e.g., the processed part 313 of FIG. 3 or the processed part 413 of FIGS. 4A to 4F) may extend in an X-axis direction on a plane of a plate 710 (e.g., the plate 310 of FIG. 3 or the plate 410 of FIGS. 4A to 4F).

In this case where the processed part 713 extends in an X-axis direction, a progress path S of a cutting process which removes the first part form the second part may be formed in a Y-axis direction which intersects the extension direction of the processed part 713 as shown in FIG. 7A, or the processing path S of the cutting process may be formed in a direction inclined to have a positive (+) inclination value with respect to an X-axis as shown in FIG. 7B or be formed in a direction inclined to have a negative (−) inclination value with respect to the X-axis as shown in FIG. 7C. That is, the progress path S of the cutting process may not be formed in a direction parallel to the processed part 713 extending in the X-axis direction.

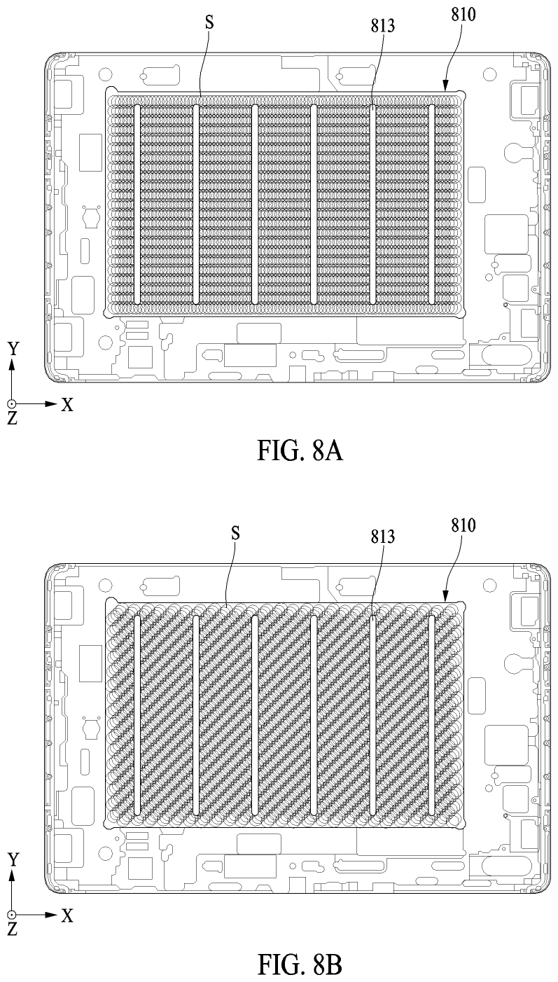

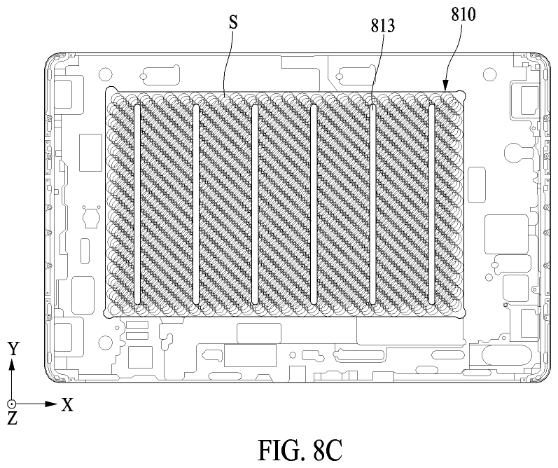

Referring to FIGS. 8A to 8C, a processed part 813 (e.g., the processed part 313 of FIG. 3 or the processed part 413 of FIGS. 4A to 4F) may extend in a Y-axis direction on a plane of a plate 810 (e.g., the plate 310 of FIG. 3 or the plate 410 of FIGS. 4A to 4F).

In this case, a progress path S of a cutting process may be formed in an X-axis direction as shown in FIG. 8A, or the progress path S of the cutting process may be formed in a direction inclined to have a positive (+) inclination value with respect to an X-axis as shown in FIG. 8B or be formed in a direction inclined to have a negative (−) inclination value with respect to the X-axis as shown in FIG. 8C. That is, the progress path S of the cutting process may not be formed in a direction parallel to the processed part 813 extending in the Y-axis direction.

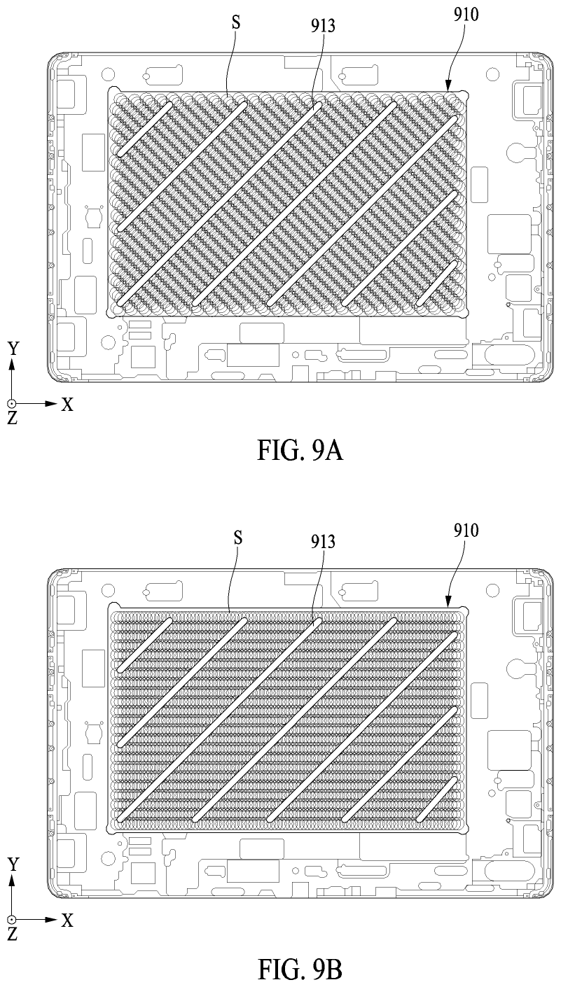

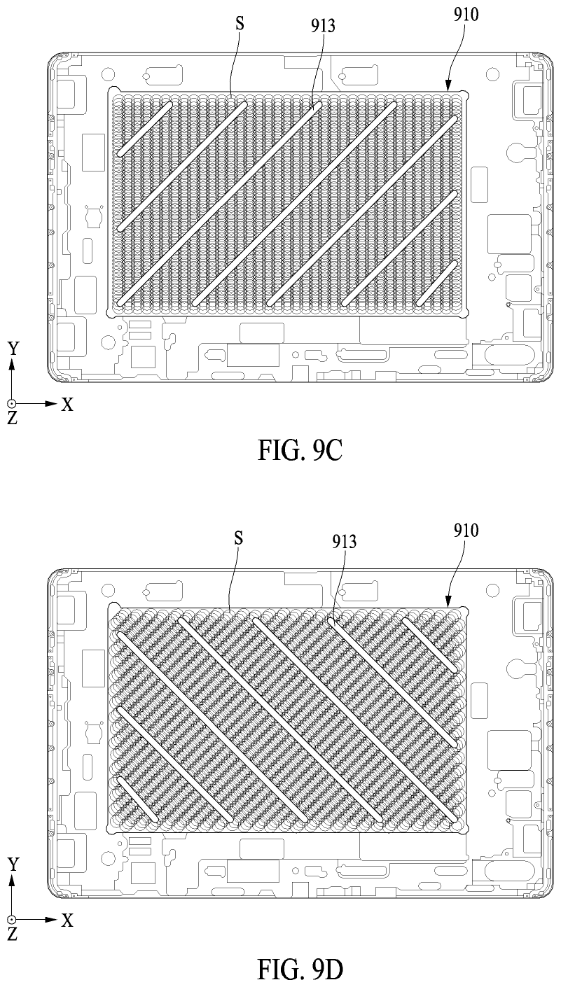

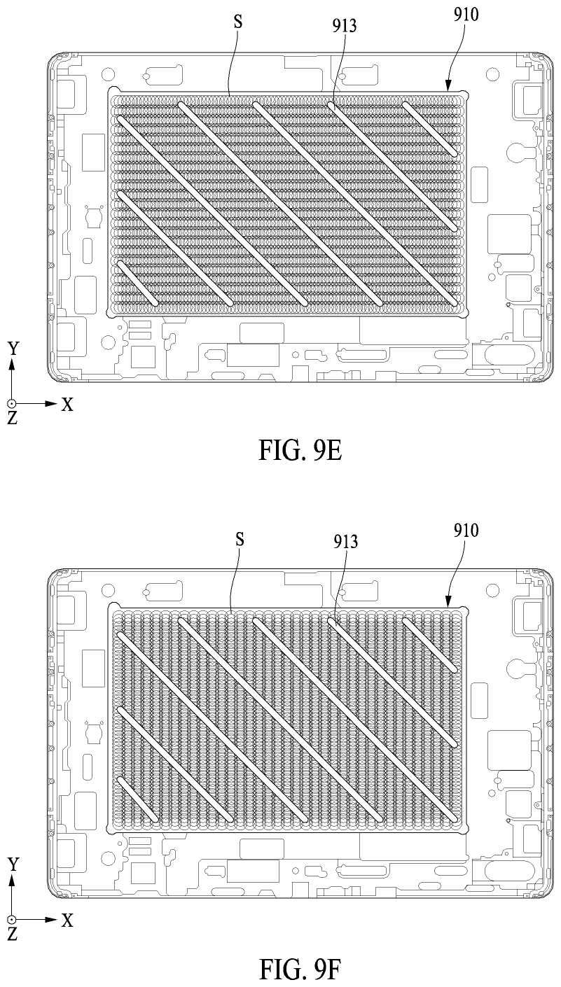

Referring to FIGS. 9A to 9F, a processed part 913 (e.g., the processed part 313 of FIG. 3 or the processed part 413 of FIGS. 4A to 4F) may extend in a direction inclined to have a positive (+) inclination value or a direction inclined to have a negative (−) inclination value with respect to an X-axis on a plate 910 (e.g., the plate 310 of FIG. 3 or the plate 410 of FIGS. 4A to 4F).

For example, as shown in FIGS. 9A to 9C, the processed part 913 may extend along a direction inclined to have a positive (+) inclination value with respect to the X-axis on the plate 910.

In this case, a progress path S of a cutting process may be in a direction inclined to have a negative (−) inclination value with respect to the X-axis as shown in FIG. 9A, or be formed in an X-axis direction as shown in FIG. 9B or in a Y-axis direction as shown in FIG. 9C. That is, the progress path S of the cutting process may not be formed in a direction parallel to the processed part 913 extending along the direction inclined to have the positive (+) inclination value with respect to the X-axis on the plate 910.

Alternatively, for example, as shown in FIGS. 9D to 9F, the processed part 913 may extend along a direction inclined to have a negative (−) inclination value with respect to the X-axis on the plate 910.

In this case, a progress path S of a cutting process may be in a direction inclined to have a positive (+) inclination value with respect to the X-axis as shown in FIG. 9D, or be formed in an X-axis direction as shown in FIG. 9E or in a Y-axis direction as shown in FIG. 9F. That is, the progress path S of the cutting process may not be formed in a direction parallel to the processed part 913 extending along the direction inclined to have the negative (−) inclination value with respect to the X-axis on the plate 910.

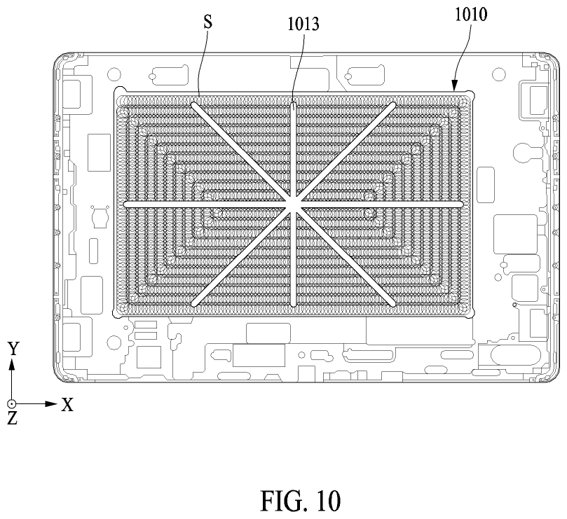

Referring to FIG. 10, a processed part 1013 (e.g., the processed part 313 of FIG. 3 or the processed part 413 of FIGS. 4A to 4F) may be arranged while crossing another on a plane of a plate 1010 (e.g., the plate 310 of FIG. 3 or the plate 410 of FIGS. 4A to 4F). For example, a plurality of processed parts 1013 may be arranged in a radial direction while crossing one another at a point on the plane of the plate 1010, to provide a radial pattern.

In this case, a progress path S of the cutting process may be in a spiral direction on a plane of the plate 1010. That is, the progress path S of the cutting process may not be formed in a direction parallel to each processed part 1013 disposed in the radial direction on the plate 1010.

According to an embodiment, a plate (e.g., 410) may include a first part (e.g., 411) forming a portion of the plate, a second part (e.g., 412) disposed on one side of the first part, and at least one processed part (e.g., 413) of the first part and the second part, where the processed part may penetrate the first part and form a groove in a portion of the second part, a cutting process may be performed on the first part, and a first surface roughness of one surface of the plate exposed by the cutting process may be different from a second surface roughness of an inner surface of the groove of the second part.

In an embodiment, a plate (310, 410, 510, 610, 710, 810, 910) is a plate layer including an inner surface (of the second part) defining a groove of the plate, a surface (4121) directly extending from the inner surface in a direction away from the groove, a first surface roughness of the surface of the plate layer, and a second surface roughness of the inner surface of which is different from the first surface roughness. The plate layer is a remaining thickness (e.g., the second part, FIG. 4G) of a preliminary plate (e.g., the first part together with the second part, like FIGS. 4A-4F) cut to remove a thickness portion of the preliminary plate. The groove (e.g., 413 in FIG. 4G) of the plate is a portion of a recessed pattern (e.g., 413) of the preliminary plate, the recessed pattern defined by the thickness portion (e.g., thickness of the first part) and the remaining thickness (e.g., thickness of the second part) facing each other within the preliminary plate (e.g., like in FIGS. 4D and 4E), and the surface (4121) of the plate layer which has the first surface roughness is an exposed surface of the remaining thickness (e.g., the second part) of the preliminary plate cut along a direction intersecting the recessed pattern (e.g., FIG. 4F) to remove the thickness portion (e.g., the first part) of the preliminary plate.

According to an embodiment, the second surface roughness may be greater than the first surface roughness.

According to an embodiment, the processed part may be formed as a plurality of processed parts, and the plurality of processed parts may be spaced apart from each other by a preset distance.

In an embodiment, the inner surface of the plate layer defines a plurality of grooves of the plate spaced apart from each other along the plate FIG. 4G or 5B, for example), and the plurality of grooves of the plate are respectively portions of a plurality of recessed patterns of the preliminary plate which are spaced apart from each other along the preliminary plate (FIGS. 4A-4F), each of the recessed patterns defined by the thickness portion (e.g., the first part) and the remaining thickness (e.g., the second part) facing each other within the preliminary plate.

According to an embodiment, the plurality of processed parts may each be formed by extending in an X-axis direction, a Y-axis direction, or a diagonal direction on a plane of the plate.

According to an embodiment, the plurality of processed parts may be arranged by crossing one another. That is, the inner surface of the plate layer (e.g., the second part) defines a plurality of grooves respectively extended in extension directions crossing each other (FIG. 10).

According to an embodiment, the plurality of processed parts may be arranged in a radial direction by crossing one another at one point of the plane of the plate.

According to an embodiment, a progress path of the cutting process for the first part may be in a direction inclined with respect to the processed part.

According to an embodiment, the progress path of the cutting process for the first part may be in a direction orthogonal to the processed part.

According to an embodiment, the progress path of the cutting process for the first part may be in an X-axis direction, a Y-axis direction, a diagonal direction, or a spiral direction on the plane of the plate. That is, the direction intersecting the extension direction of the groove is a linear direction (FIGS. 6A-6C) or a spiral direction (FIG. 6D).

According to an embodiment, the first part and the second part may be formed of the same material.

According to an embodiment, a width of the processed part formed through the first part may be approximately 4 mm or greater.

According to an embodiment, a depth of the groove of the second part may be less than approximately ½ of a thickness of the second part.

According to an embodiment, a cross-sectional shape of one end of the processed part may be substantially a circular or polygonal shape.

According to an embodiment, an inner surface of the processed part may have a surface roughness of Ra 2.0 um or greater by the chemical etching process.

According to an embodiment, an electronic device may include a battery, and a plate (e.g., 410) on which the battery is seated, where the plate may include a flat part (e.g., 411) forming a portion of the plate, a second part (e.g., 412) disposed on one side of the first part, and at least one processed part (e.g., 413) of the first part and the second part, where the processed part may penetrate the first part and form a groove in a portion of the second part, a cutting process may be performed on the first part, and a first surface roughness of one surface of the plate exposed by the cutting process may be less than a second surface roughness of an inner surface of the groove of the second part.

In an embodiment, the plate includes an inner surface at the second part defining a groove of the plate, a cut surface (4121) directly extending from the inner surface in a direction away from the groove, a first surface roughness of the cut surface of the plate, and a second surface roughness of the inner surface of which is different from the first surface roughness.

According to an embodiment, the processed part may be formed as a plurality of processed parts, and the plurality of processed parts may be spaced apart by a preset distance and may each be formed by extending in an X-axis direction, a Y-axis direction, or a diagonal direction on a plane of the plate.

The cut surface of the plate may be a flat surface, and the groove of the plate may be provided in plural including a plurality of grooves recessed from the flat surface and spaced apart from each other along the plate. Alternatively, the groove of the plate may be provided in plural including a plurality of grooves recessed from the flat surface and crossing each other at a point.

According to an embodiment, the plurality of processed parts may be arranged in a radial direction while crossing one another at one point of the plane of the plate.

According to an embodiment, a progress path of the cutting process for the first part may be in a direction inclined with respect to the processed part, and in an X-axis direction, a Y-axis direction, a diagonal direction, or a spiral direction on the plane of the plate.

According to an embodiment, a width of the processed part formed through the first part may be approximately 4 mm or greater, and a depth of the groove of the second part may be less than approximately ½ of a thickness of the second part.

According to an embodiment, an electronic device may include a battery, and a plate (e.g., 410) (e.g., a second part 412) on which the battery is disposed, where the plate 410 may include a plurality of grooves, and a first surface roughness of the plate 410 may be less than a second surface roughness of an inner surface of the plurality of grooves.

According to an embodiment, a method of manufacturing a plate may include forming a processed part on the plate, performing a chemical etching process on the plate, and performing a cutting process on one surface of the plate, where the plate may include a first part forming a portion of the plate, a second part disposed on one side of the first part, and at least one processed part of the first part and the second part, where the processed part may penetrate the first part and form a groove in a portion of the second part, a cutting process may be performed on the first part, and a first surface roughness of one surface of the plate exposed by the cutting process may be less than a second surface roughness of an inner surface of the groove of the second part.

According to an embodiment, an electronic device may include a battery, and a plate on which the battery is seated, where the plate may include a flat part (e.g., a second part 412) that is formed to be substantially flat, where the flat part may include a first surface (e.g., one surface 4121 of the second part) formed to have a first surface roughness by a cutting process, and a second surface (e.g., a groove 4131 of the second part) disposed in a portion of the first surface and formed to have a second surface roughness greater than the first surface roughness.

According to an embodiment, the first surface may be formed as a flat surface, and the second surface may be formed in a shape recessed in a direction facing an inner side of the flat part, where the second surface may be formed as a plurality of second surfaces, each of which may be spaced apart by a preset distance on the first surface.

According to an embodiment, the plurality of second surfaces may each be formed by extending in an X-axis direction, a Y-axis direction, or a diagonal direction on the first surface, or may be arranged in a radial direction while crossing each other at one point of the first surface.

According to an embodiment, a depth of the second surface may be less than approximately ½ of a thickness of the flat part, and the second surface roughness may be greater than or equal to Ra 2.0 um.

According to an embodiment, a method of providing a housing plate of an electronic device includes providing a preliminary housing plate including a plurality of layers including a first layer and a second layer facing each other, a recessed pattern defined penetrating the first layer and extended into the second layer, the recessed pattern at the second layer corresponding to a groove of the housing plate, and the recessed pattern extended in an extension direction along the preliminary housing plate, and removing the first layer of the preliminary housing plate from the second layer, to expose an upper surface of the second layer. The second layer having the upper surface which is exposed defines the housing plate.

An inner surface of the first layer and an inner surface of the second layer together define the recessed pattern of the preliminary housing plate, and a surface roughness of the inner surface of the second layer is approximately Ra 2.0 micrometers or greater.

The method may further including chemical etching the recessed pattern of the preliminary housing plate having the recessed pattern defined by the inner surface of the first layer together with the inner surface of the second layer.

The surface roughness of the inner surface of the second layer may be different from a surface roughness of the upper surface which is exposed by the removing of the first layer of the preliminary housing plate from the second layer.

The removing of the first layer of the preliminary housing plate from the second layer may include a cutter cutting away the first layer in a cutting direction along the preliminary housing plate, and the cutting direction crosses the extension direction of the recessed pattern of the preliminary housing plate.

What is claimed is:

1. A plate of a housing within an electronic device, the plate comprising:
a plate layer comprising:
an inner surface defining a groove of the plate which extends in an extension direction;
a cut surface directly extending from the inner surface in a direction away from the groove;
a first surface roughness of the cut surface of the plate layer; and
a second surface roughness of the inner surface of which is different from the first surface roughness,
wherein
the plate layer is a remaining thickness of a preliminary plate cut to remove a thickness portion of the preliminary plate,
the groove of the plate is a portion of a recessed pattern of the preliminary plate, the recessed pattern defined by the thickness portion and the remaining thickness facing each other within the preliminary plate, and
the cut surface of the plate layer which has the first surface roughness is an exposed surface of the remaining thickness of the preliminary plate cut along a direction intersecting the extension direction of the groove to remove the thickness portion of the preliminary plate.

2. The plate of claim 1, wherein the second surface roughness is greater than the first surface roughness.

3. The plate of claim 1, wherein
the inner surface of the plate layer defines the groove provided in plural including a plurality of grooves of the plate spaced apart from each other along the plate, and
the plurality of grooves of the plate are respectively portions of a plurality of recessed patterns of the preliminary plate which are spaced apart from each other along the preliminary plate, each of the recessed patterns defined by the thickness portion and the remaining thickness facing each other within the preliminary plate.

4. The plate of claim 1, wherein the extension direction of the groove of the plate layer extends in an X-axis direction, a Y-axis direction or a diagonal direction.

5. The plate of claim 1, wherein the inner surface of the plate layer defines the groove provided in plural including a plurality of grooves respectively extended in extension directions crossing each other.

6. The plate of claim 1, wherein the direction intersecting the extension direction of the groove is inclined or orthogonal to the extension direction of the groove.

7. The plate of claim 6, wherein the direction intersecting the extension direction of the groove is a linear direction or a spiral direction.

8. The plate of claim 1, wherein the plate layer of the plate and the thickness portion of the preliminary plate include a same material as each other.

9. The plate of claim 1, wherein
a width of the recessed pattern at the thickness portion is approximately 4 millimeters or greater,
the plate layer has a thickness, and
a depth of the groove of the plate is less than approximately ½ of the thickness of the plate layer.

10. The plate of claim 1, wherein a cross-sectional shape of the recessed pattern is a portion of a circle or a polygon.

11. The plate of claim 1, wherein the inner surface defining the groove of the plate has a surface roughness of Ra 2.0 micrometers or greater.

12. An electronic device comprising:
a battery; and
a plate on which the battery is seated,
wherein the plate comprises:
an inner surface defining a groove of the plate;
a cut surface directly extending from the inner surface in a direction away from the groove;
a first surface roughness of the cut surface of the plate; and
a second surface roughness of the inner surface of which is different from the first surface roughness.

13. The electronic device of claim 12, wherein
the cut surface of the plate is a flat surface, and
the groove of the plate is provided in plural including a plurality of grooves recessed from the flat surface and spaced apart from each other along the plate.

14. The electronic device of claim 12, wherein
the cut surface of the plate is a flat surface, and
the groove of the plate is provided in plural including a plurality of grooves recessed from the flat surface and crossing each other at a point.

15. The electronic device of claim 12, wherein
the plate has a thickness,
a depth of the groove is less than approximately ½ of the thickness of the plate, and
the second surface roughness is greater than or equal to about Ra 2.0 micrometers.

16. A method of providing a housing plate of an electronic device, the method comprising:
providing a preliminary housing plate comprising:
a plurality of layers including a first layer and a second layer facing each other,
a recessed pattern defined penetrating the first layer and extended into the second layer, the recessed pattern at the second layer corresponding to a groove of the housing plate, and
the recessed pattern extended in an extension direction along the preliminary housing plate, and
removing the first layer of the preliminary housing plate from the second layer, to expose an upper surface of the second layer,
wherein the second layer having the upper surface which is exposed defines the housing plate.

17. The method of claim 16, wherein:
an inner surface of the first layer and an inner surface of the second layer together define the recessed pattern of the preliminary housing plate, and
a surface roughness of the inner surface of the second layer is approximately Ra 2.0 micrometers or greater.

18. The method of claim 17, further comprising chemical etching the recessed pattern of the preliminary housing plate having the recessed pattern defined by the inner surface of the first layer together with the inner surface of the second layer.

19. The method of claim 17, wherein the surface roughness of the inner surface of the second layer is different from a surface roughness of the upper surface which is exposed by the removing of the first layer of the preliminary housing plate from the second layer.

20. The method of claim 16, wherein:
the removing of the first layer of the preliminary housing plate from the second layer includes a cutter cutting away the first layer in a cutting direction along the preliminary housing plate, and
the cutting direction crosses the extension direction of the recessed pattern of the preliminary housing plate.
